(19) United States
(12) Patent Application Publication
(10) Pub. No.: US 2026/0075570 A1
(43) Pub. Date: Mar. 12, 2026

(54) AI-BASED POSITIONING METHOD AND DEVICE PERFORMING THE SAME

(71) Applicant: ELECTRONICS AND TELECOMMUNICATIONS RESEARCH INSTITUTE, Daejeon (KR)

(72) Inventors: Jihoon SUNG, Daejeon (KR); Myung Ki SHIN, Seoul (KR)

(73) Assignee: ELECTRONICS AND TELECOMMUNICATIONS RESEARCH INSTITUTE, Daejeon (KR)

(21) Appl. No.: 19/296,334

(22) Filed: Aug. 11, 2025

(30) Foreign Application Priority Data
Aug. 9, 2024 (KR) 10-2024-0107006
Aug. 28, 2024 (KR) 10-2024-0115848
Oct. 23, 2024 (KR) 10-2024-0146103
Dec. 4, 2024 (KR) 10-2024-0178697
Aug. 7, 2025 (KR) 10-2025-0109192

(51) Int. Cl. H04W 64/00; H04L 41/16; H04W 40/16

(52) U.S. Cl. CPC H04W 64/00; H04L 41/16; H04W 40/16

(57) ABSTRACT

An artificial intelligence (AI)-based positioning method and a device for performing the same are disclosed. According to an embodiment, the AI-based positioning method includes receiving a request for positioning of a user equipment (UE) from a consumer network function (NF), among legacy positioning and AI-based positioning, determining to perform the AI-based positioning for the positioning, receiving information of an AI positioning model for the AI-based positioning from a fifth generation (5G) core (5GC) NF, collecting data for a learning and inference operation of the AI positioning model from the 5GC NF, generating location information of the UE by performing the AI-based positioning based on the received information and the collected data, and transmitting the generated location information to the consumer NF.

### TECHNICAL FIELD

The disclosure relates to an artificial intelligence (AI)-based positioning method and a device performing the same.

### BACKGROUND OF THE INVENTION

As mobile communication systems evolve to provide optimized services for terminals, the importance of positioning technology for terminals is increasing.

Recently, advanced technology for precise terminal positioning using artificial intelligence (AI) has attracted attention, but detailed methods and procedures for AI-based terminal positioning in mobile communication systems remain undefined.

A detailed method and procedure for enhancing mobile communication systems to enable precise terminal positioning using AI technology are in demand.

The above description has been possessed or acquired by the inventor(s) in the course of conceiving the present disclosure and is not necessarily an art publicly known before the present application is filed.

### DISCLOSURE OF THE INVENTION

### [Technical Goals]

While advanced technology for precise terminal positioning using artificial intelligence (AI) has recently gained attention, existing mobile communication systems may lack the support methods and procedures for AI-based terminal positioning.

An embodiment may provide a detailed method and procedure for enhancing mobile communication systems to enable precise terminal positioning using AI technology.

However, the technical aspects are not limited to the aforementioned aspect, and other technical aspects may be present.

### Technical Solutions

According to an embodiment, an artificial intelligence (AI)-based positioning method includes receiving a request for positioning of a user equipment (UE) from a consumer network function (NF), among legacy positioning and AI-based positioning, determining to perform the AI-based positioning for the positioning, receiving information of an AI positioning model for the AI-based positioning from a fifth generation (5G) core (5GC) NF, collecting data for a learning and inference operation of the AI positioning model from the 5GC NF, generating location information of the UE by performing the AI-based positioning based on the received information and the collected data, and transmitting the generated location information to the consumer NF.

The collected data may include a location of the UE collected according to a positioning scheme different from the AI-based positioning.

The method may further include storing the generated location information in the 5GC NF to reuse the generated location information.

The reusing may include at least one of training and retraining of the AI positioning model.

The method may be performed by a location management function (LMF), and the LMF may be selected by an access and mobility management function (AMF) for the positioning of the UE based on at least one of an AI-based positioning support function and serving UE information.

The AMF may select a different LMF based on at least one of the AI-based positioning support function and the serving UE information when the LMF is unable to normally support the AI-based positioning.

The method may further include requesting discovery of a second NF supporting training of the AI positioning model to a first NF of the 5GC NF, receiving information on the second NF from the 5GC NF, and requesting the information of the AI positioning model to the second NF.

The second NF may pre-register an NF profile including an indication of whether training of the AI positioning model is supported in the first NF.

The second NF may train the AI positioning model based on training data collected from a selected UE.

The training data may be collected according to a request for positioning to the selected UE.

The request for the positioning to the selected UE may be triggered by data collection for the AI positioning model rather than a location service (LCS) request from an LCS client and an LCS consumer.

The request for the positioning to the selected UE may include an indication that data is collected for model training, a positioning method or a measurement type of positioning, a data source generating data, and a data time window for data collection.

According to an embodiment, a server device for performing AI-based positioning includes a processor, and memory electrically connected to the processor and storing instructions executable by the processor, wherein the instructions, when executed by the processor, may cause the server device to perform a plurality of operations including receiving a request for positioning of a UE from a consumer NF, among legacy positioning and AI-based positioning, determining to perform the AI-based positioning for the positioning, receiving information of an AI positioning model for the AI-based positioning from a 5GC NF, collecting data for an inference operation of the AI positioning model from the 5GC NF, generating location information of the UE by performing the AI-based positioning based on the received information and the collected data, and transmitting the generated location information to the consumer NF.

The collected data may include a location of the UE collected according to a positioning scheme different from the AI-based positioning.

The plurality of operations may further include storing the generated location information in the 5GC NF to reuse the generated location information.

The reusing may include at least one of training and retraining of the AI positioning model.

The plurality of operations may be performed by an LMF, and the LMF may be selected by an AMF for the positioning of the UE based on at least one of an AI-based positioning support function and serving UE information.

The AMF may select a different LMF based on at least one of the AI-based positioning support function and the serving UE information when the LMF is unable to normally support the AI-based positioning.

The plurality of operations may further include requesting discovery of a second NF supporting training of the AI positioning model to a first NF of the 5GC NF, receiving information on the second NF from the first NF of the 5GC NF, and requesting the information of the AI positioning model to the second NF.

The second NF may pre-register an NF profile including an indication of whether training of the AI positioning model is supported in the first NF.

### Effects of the Invention

An embodiment may enhance mobile communication system functionality for artificial intelligence (AI)-based positioning, which is a feature not previously supported in fifth generation (5G) mobile communication systems. By enabling precise terminal positioning, an embodiment may ultimately improve the quality of service experienced by terminals in mobile communication systems.

### BRIEF DESCRIPTION OF DRAWINGS

FIG. 1 illustrates a network system according to an embodiment.

FIG. 2 is a diagram illustrating a positioning process according to an embodiment.

FIG. 3 is a flowchart illustrating an artificial intelligence (AI)-based positioning method according to an embodiment.

FIG. 4 is a flowchart illustrating a training method of an AI positioning model according to an embodiment.

FIG. 5 is a schematic block diagram of a device for performing a network function (NF) according to an embodiment.

### BEST MODE FOR CARRYING OUT THE INVENTION

The following structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” to another component, it may be understood that the one component is directly connected to another component or that still other component is interposed between the two components.

The singular forms “a”, “an”, and “the” are intended to include the plural forms as well, unless the context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The term “unit” or the like used herein may refer to a software or hardware component, such as a field-programmable gate array (FPGA) or an ASIC, and the “unit” performs predefined functions. However, the term “unit” is not limited to software or hardware. A “unit” may be configured to be in an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, embodiments will be described in detail with reference to the accompanying drawings. When describing the embodiments with reference to the accompanying drawings, like reference numerals refer to like components, and any repeated description related thereto will be omitted.

The terms used herein to identify connection nodes, terms referring to network entities, terms referring to messages, terms referring to interfaces between network entities, and terms referring to various identification information are provided for ease of description. Therefore, the disclosure is not limited to the terms described below, and other terms that refer to objects with equivalent technical meanings may be used.

For ease of description, the disclosure uses terms and names defined in long-term evolution (LTE) and new radio (NR) standards, which are the most recent standards defined by the 3^{rd} Generation Partnership Project (3GPP), among existing communication standards. However, the embodiments described hereinafter are not limited by these common terms and names and may be equally applied to systems conforming to other standards.

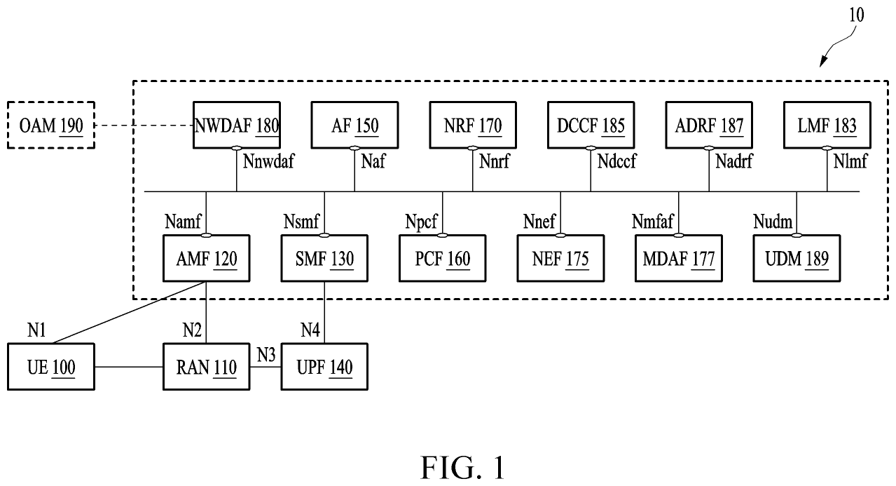

FIG. 1 illustrates a network system according to an embodiment.

Referring to FIG. 1, a network system 10 (e.g., a fifth generation (5G) network system, a sixth generation (6G) network system or 5G/6G network system) according to an embodiment may include a plurality of entities 100 to 190. The user equipment (UE) 100 may access a 5G core network through a radio access network (RAN) 110. The RAN 110 may refer to a base station providing wireless communication functions to the UE 100. Operation, administration, and maintenance (OAM) 190 may be a system for managing terminals and networks.

A unit for performing each function provided by the network system 10 may be defined as a network function (NF). An NF may include an access and mobility management function (AMF) 120, session management function (SMF) 130, user plane function (UPF) 140, application function (AF) 150, policy control function (PCF) 160, network repository function (NRF) 170, network exposure function (NEF) 175, management data analytics function (MDAF) 177, network data analytics function (NWDAF) 180, location management function (LMF) 183, data collection coordination function (DCCF) 185, analytics data repository function (ADRF) 187, and unified data management (UDM) 189. The AMF 120 may manage network access and mobility of a terminal, the SMF 130 may perform session-related functions, the UPF 140 may transmit user data, and the AF 150 may communicate with 5G core (5GC) to provide application services. The PCF 160 may manage policy, and the NRF 170 may store state information of NFs and process requests for other NFs to find a required NF.

The LMF 183 may calculate and/or correct a location of the UE 100. The LMF 183 may integrate and manage various positioning techniques and exchange positioning-related data with an NF. The LMF 183 may receive a request for positioning of the UE 100 from a consumer NF (e.g., the AMF 120), generate location information of the UE 100 by performing positioning based on another NF (e.g., the NRF 170, NWDAF 180, or ADRF 187), and transmit the generated location information to the consumer NF.

For example, the positioning techniques may include legacy positioning and artificial intelligence (AI)-based positioning. According to an embodiment, enhancements to location service (LCS) may be provided through the LMF 183 to support direct AI-based positioning.

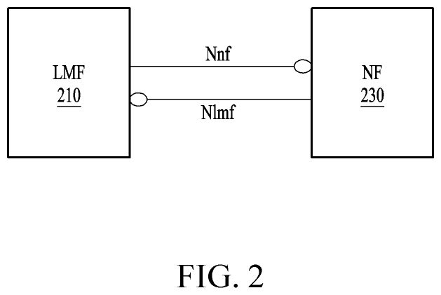

FIG. 2 is a diagram illustrating a positioning process according to an embodiment.

An LMF 210 (e.g., the LMF 183 of FIG. 1) may provide a positioning service to an NF 230. The NF 230 may be a consumer NF (e.g., the AMF 120). The LMF 210 may support direct AI-based positioning. In supporting the direct AI-based positioning, the LMF 210 may perform AI model-based positioning. The AI model may be simply referred to as an AI model or a machine learning (ML) model. An interaction between the LMF 210 and a model training logical function (MTLF) may be only for model provisioning or data collection for training.

When a request for a location of a UE is received, the LMF 210 may select a method appropriate to determine the location of the UE, for example, AI positioning may be selected as an appropriate method.

The LMF 210 may perform model training for AI-based positioning. Triggers for data collection and model training in the LMF 210 may vary depending on the implementation. The MTLF may perform model training for AI-based positioning. The MTLF may be included in an NWDAF (e.g., the NWDAF 180 of FIG. 1).
To retrieve a model to perform positioning, the LMF 210 may discover a suitable MTLF via an NRF.
An NWDAF including an MTLF may train an ML model for AI-based positioning based on a request from the LMF 210 or an internal trigger.
The MTLF may collect training data (e.g., data as defined by the RAN for AI-based positioning and/or historical data stored in an ADRF (e.g., the ADRF 187 of FIG. 1)) from a data source.

The LMF 210 and/or MTLF may perform model performance monitoring for AI-based positioning.
A result of the model performance monitoring may trigger the LMF 210 to change the positioning method (e.g., from AI-based positioning to legacy positioning, or vice versa).
The result of the model performance monitoring may trigger retraining of the ML model in the training entity.

A user's authorization and/or consent for collecting UE related training data may be required as specified in TS 23.288 [5] and TS 23.273 [7].

The LMF 210 may manage the overall co-ordination and scheduling of resources required for the positioning of a UE that is registered with or accessing a 5th generation core network (5GCN). The LMF 210 may calculate or verify a final location and all velocity estimates and estimate the achieved accuracy. The LMF 210 may receive a location request for a target UE from a serving AMF using an Nlmf interface. The LMF 210 may interact with a UE to exchange location information applicable to UE assisted and UE-based positioning methods and interact with a next generation RAN (NG-RAN), non-3rd generation partnership project (3GPP) interworking function (N3IWF) and/or trusted non-3GPP access network (TNAN) to obtain location information.

The LMF 210 may determine a result of positioning in geographical co-ordinates (e.g., geographical co-ordinates as defined in TS 23.032 [8]) and/or in local co-ordinates (e.g., local co-ordinates as defined in TS 23.032 [8]). When requested and when available, the result of positioning may include a velocity of a UE. When a location request is received, the LMF 210 may determine a co-ordinate type(s) based on an LCS client type and a supported universal geographical area description (GAD) shape. When the location request indicates a regulatory LCS client type, the LMF 210 may determine geographical location co-ordinates, and optionally co-ordinates of a local location. For a location request indicating a value added LCS client type, the LMF 210 may determine the UE location in geographical co-ordinates, local co-ordinates or both. When a supported GAD shape is not received or local co-ordinates are not included in the supported GAD shape, the LMF 210 may determine a geographical location.

A radio access technology (RAT)-independent positioning method (e.g., a global navigation satellite system (GNSS)-based positioning method) may determine a UE location using geographical co-ordinates. In such a case, the LMF 210 may translate a UE location in geographical co-ordinates into a location in local co-ordinates when an origin for the local co-ordinates has known global co-ordinates. When an origin for the local co-ordinates does not have known global co-ordinates, a position method only determining a UE location in geographical co-ordinates may not be used to determine a UE location in local co-ordinates.

Additional functions which may be performed by the LMF 210 to support location services may include the following.
The LMF 210 may support a request for a single location received from a serving AMF for a target UE.
The LMF 210 may support a request for a periodic or triggered location received from a serving AMF for a target UE.
The LMF 210 may determine a type and number of position methods and procedures based on UE and public land mobile network (PLMN) functions, quality of service (QOS), UE connectivity state per access type, LCS client type, co-ordinate type and optionally service type and an indication of request for reliable UE location information.
The LMF 210 may report UE location estimates directly to a gateway mobile location center (GMLC) for periodic or triggered positioning of a target UE.
The LMF 210 may support cancellation of periodic or triggered positioning for a target UE.
The LMF 210 may support the provision of broadcast assistance data to a UE via NG-RAN in ciphered or unciphered form, and forward ciphering keys to a subscribed UE via an AMF.
The LMF 210 may support change of a serving LMF 210 for periodic or triggered positioning reporting for a target UE.
The LMF 210 may support the receiving of stored UE positioning functions from the AMF and support the provision of updated UE positioning functions to the AMF.
The LMF 210 may map a UE location to a geographical area where the PLMN is or is not allowed to operate based on a request from the AMF.
The LMF 210 may support determination of a UE location at a scheduled positioning time.
The LMF 210 may support determination of indoor or outdoor for a location estimate.
The LMF 210 may determine whether to use a user plane or control plane for positioning.
The LMF 210 may support the handling of a 5GC mobile terminated location request (5GC-MT-LR), 5GC network induced location request (5GC-NI-LR), 5GC mobile originated location request (5GC-MO-LR) and deferred 5GC-MT-LR for periodic or triggered location over a user plane connection between a UE and the LMF 210 over transport layer security (TLS).

How the LMF 210 uses the UE user plane positioning function (e.g., received UE user plane positioning function for SUPL [49]) may depend on the implementation.
The LMF 210 may support the collection of GNSS assistance data from an AF.
The LMF 210 may support service level positioning reference unit (PRU) association, PRU association update and/or PRU disassociation.
i) The LMF 210 may verify a PRU initiated association or disassociation by checking whether there is a PRU verified indication from the AMF.
ii) The LMF 210 may store the received PRU information included in a service level PRU association message and remove the PRU information after PRU disassociation.
iii) The LMF 210 may maintain PRU information for a PRU in an OFF state.
iv) The LMF 210 may indicate support of a PRU function to an NRF via an NF profile and may further transmit the PRU indication via an NF profile update when a PRU is a stationary PRU.
v) The LMF 210 may request a PRU to associate to a new LMF by returning a routing ID of the new LMF.

PRU ON/OFF states may indicate temporary availability (e.g., PRU OFF due to other high priority tasks/energy saving at the UE and/or a UE temporarily loses network coverage) of the PRU functionality of a UE at a serving LMF.
The LMF 210 may support selection of a PRU based on stored PRU information when the LMF 210 is required to obtain positioning values from the PRU to assist the positioning of a target UE.
The LMF 210 may support the obtaining of PRU positioning values as described in clause 5.4.5 of TS 38.305 [9] by triggering the procedure in clause 6.11.
The LMF 210 may support the obtaining of PRU positioning values from other PRU serving LMF(s).
i) As a serving LMF of target UE(s), the LMF 210 may support discovery and selection of other PRU serving LMF(s) by querying the NRF(s) and may support the requesting of PRU positioning values from the selected LMF(s).
ii) As a serving LMF of PRU(s), the LMF 210 may support to provide PRU positioning values to other LMF(s) after receiving a request from the other LMF(s).
The LMF 210 may support to determine a UE location by considering the obtained PRU positioning values.

A country, an area within a country, or an international area may be supported as different types of geographical area.
The LMF 210 may support a request for user plane reporting from a UE to an LCS client or AF for a periodic or triggered 5GC-MT-LR. Subsequently, the LMF 210 may support the transfer of cumulative event reports from a target UE via control plane to a home GMLC (H-GMLC) and LCS Client or AF. Also, the LMF 210 may support a request for assistance data received in a cumulative event report.
The LMF 210 may determine a UE location for a UE connected to a mobile base station relay (MBSR) based on location and velocity of the MBSR and/or a timing of the location estimations for the target UE and MBSR.
For a regulatory location service, the LMF 210 may support the reporting of multiple intermediate location estimates to the GMLC.
The LMF 210 may determine whether to use AI-based positioning (e.g., using an ML model for UE positioning).
The LMF 210 may support to determine whether UE/RAN supports AI-based positioning based on UE/RAN functions.
The LMF 210 may support data collection from the UE, PRU and/or RAN and/or data exposure for the model training of AI-based positioning.

The NRF may perform the following functions. The following functions may be additional functions beyond those defined in TS 23.501 [18],
The NRF may support to store or update PRU existence indication in a tracking area identity (TAI) level in an LMF profile based on a request from a PRU serving LMF.
The NRF may support LMF(s) with PRU function discovery by the AMF.
The NRF may discover the LMF 210 by considering user plane positioning functionality.
The NRF may support LMF(s) associated with PRUs' discovery by other LMF(s), according to a target area in the discovery request and profiles of the LMF 210 with PRU existence indication in the TAI level.
The NRF may perform the LMF discovery function by considering AI-based positioning functionality.
The NRF may support the LMF discovery function by considering data collection and exposure functionality for the model training of AI-based positioning.

The AMF may support LMF selection functionality to determine the LMF 210 for location estimation of the target UE or ranging/sidelink (SL) positioning between the target UE and SL reference UE. The LMF selection functionality may also be supported by the corresponding LMF 210 when the LMF 210 determines that it is unsuitable or unable to support positioning for a current UE access network or serving cell for the deferred 5GC-MT-LR procedure for periodic, triggered location events, and/or modification of user plane connection. The LMF selection functionality may also be supported by the GMLC. The GMLC may provide a selected LMF ID to the AMF.

LMF reselection may be a functionality supported by the AMF when necessary (e.g., due to UE mobility). The LMF selection/reselection may be performed at the AMF or LMF 210 or GMLC based on locally available information (e.g., LMF profiles may be configured locally at AMF or LMF or GMLC, or by querying NRF).

The following factors may be considered during the LMF selection:
LCS client type.
Requested QoS information, e.g.:
   i) LCS accuracy,
   ii) Response time (latency),
Access type (e.g., 3GPP/non-3GPP (N3GPP)).

Positioning methods may differ depending on the access type. For example, in the case of wireless local area network (WLAN) access, location determination may just correspond to retrieval of internet protocol (IP) addressing information from the N3IWF/trusted non-3GPP gateway function (TNGF). As another example, for wireline access, location determination may just correspond to retrieval of geographical co-ordinates corresponding to a global line identifier (GLI) as defined in clause 4.7.8 of TS 23.316 and/or a hybrid fiber-coaxial (HFC) node ID.
RAT type (e.g., 5G new radio (NR), enhanced long term evolution (eLTE), or any of the RAT types specified for NR satellite access) and/or a serving access network (AN) node (e.g., next generation node B (gNB) or next generation evolved node B (NG-eNB)) of a target UE.
RAN configuration information.
LMF functions, including:
   i) Support of Uu based positioning as defined in clause 4.3.8
   ii) Support of ranging/SL positioning as defined in clause 4.3.8 of TS 23.586
   iii) LMF user plane positioning functions (the capability to support location service-user plane protocol (LCS-UPP)).
   iv) Support of AI-based positioning
   v) Data collection and exposure functionality for model training of AI-based positioning
LMF load.
LMF location.
Indication of either a single event report or multiple event reports.
Duration of event reporting.
Network slicing information (e.g., single network slice selection assistance information (S-NSSAI) and/or network slice instance identifier (NSI ID).
LMF service area including at least one tracking area (TA) (s).
Supported GAD shapes.
Support LCS when MBSR is involved.
Requested UE has maintained user plane connection with certain LMFs.

When a non-access stratum (NAS) message is received from the UE, including an LMF ID together with an LTE positioning protocol (LPP) message (refer to step 25 in clause 6.3.1 for event reporting for a deferred 5GC-MT-LR), the AMF may send the LPP message to the LMF, as indicated by the LMF ID.

Description on how the UE encapsulates the LMF ID in the NAS message is documented in TS 24.571 [36].

A UDM (e.g., the UDM 189 of FIG. 1) may store the LMF ID in UE subscription data. During the positioning procedure, GMLC may receive the LMF ID from the UDM and provide the LMF ID to AMF.

A GMLC may be configured with the following parameters:
LMF ID and/or
per group ID and its correlating LMF ID.

The AMF may use a locally provisioned configuration to determine the LMF 210 based on UE identification or UE group information.

The priority of different selection criteria of the GMLC, AMF and LMF 210 may be AMF implementation specific.

When the GMLC receives a mobile terminal (MT) location request from an LCS client/AF, the GMLC may determine the LMF ID based on configured parameters for the LCS client/AF. In case a group ID is provided or derived from the location request, the GMLC may determine the corresponding LMF ID based on the provisioned group ID.

The GMLC may be configured with one or several dedicated LMF ID(s), irrelevant to an LCS client/AF. When the GMLC receives an MT location request from an LCS client/AF, the GMLC may only determine the LMF ID within the configuration for all LCS clients/AFs.

When the AMF is unable to access an LMF instance of the LMF ID, the AMF may reply with the corresponding error to the GMLC. The GMLC may retry or fail the request accordingly. In such a case, with explicit configuration to serve as backup selection, the AMF may also select a different configured LMF instance.

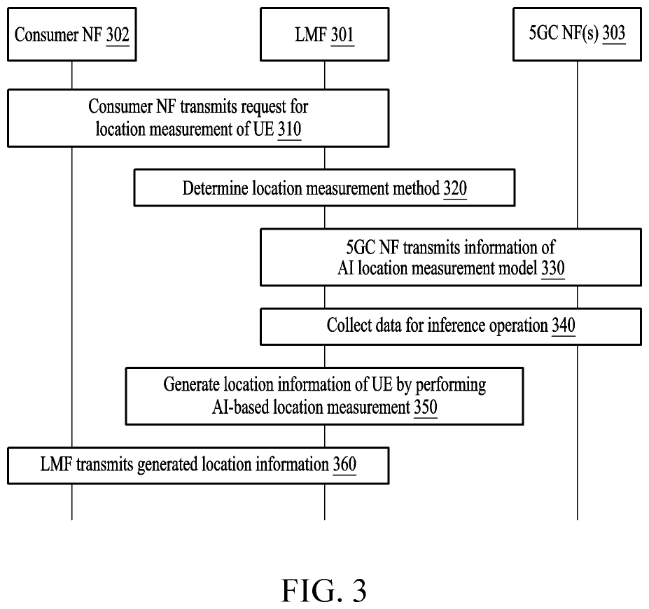

FIG. 3 is a flowchart illustrating an AI-based positioning method according to an embodiment. Referring to FIG. 3, in operation 310, a consumer NF 302 (e.g., an AMF (e.g., the AMF 120 of FIG. 1)) may transmit a request for positioning of a UE to an LMF 301 (e.g., the LMF 183 of FIG. 1 and/or the LMF 210 of FIG. 2). The UE may trigger a 5GC-MO-LR procedure, or an LCS client may trigger a 5GC-MT-LR procedure as defined in TS 23.273 [7].

In operation 320, the LMF 301 may determine a positioning method. The LMF 301 may determine to perform AI-based positioning for the positioning among legacy positioning and AI-based positioning. The LMF 301 may determine whether to use legacy UE positioning methods as defined in TS 23.273 [7] or an AI-based positioning method to derive UE location information based on internal logic (e.g., considering AI-based positioning related function and/or measurement data reported from UE (case 2b) or RAN (case 3b) of the LMF 301) of the LMF 301. When the LMF 301 determines to use an AI-based positioning method, the following operations may be performed.

In operation 330, a 5GC NF 303 may transmit to the LMF 301 information of an AI positioning model for AI-based positioning. For example, the 5GC NF 303 may include at least one of the NFs (e.g., the SMF 130, UPF 140, AF 150, PCF 160, NRF 170, NEF 175, MDAF 177, NWDAF 180, DCCF 185, ADRF 187, and UDM 189) of FIG. 1 and the NF 230 of FIG. 2.

When the LMF 301 determines to use AI-based positioning to obtain a UE location and there is no appropriate ML model available for the AI-based positioning, then the LMF 301 may discover an NWDAF (e.g., a second NF) including an MTLF supporting model training for AI-based positioning via an NRF (e.g., a first NF) by invoking an Nnrf_NFDiscovery_Request service operation (direct AI positioning model, ML model filter information, and NF consumer information (e.g., a vendor ID of the LMF 301)). The NRF may notify the LMF 301 with at least one NWDAF including MTLF instances.

Before that, the NWDAF including the MTLF may register its NF profile (including indication of supporting ML model training for direct AI positioning, ML model filter information, and an ML model interoperability indicator) into an NRF via an Nnrf_NFManagement_NFRegister service.

Then the LMF 301 may retrieve an ML model for AI-based positioning from the NWDAF including the MTLF by invoking Nnwdaf_MLModelProvision_Subscribe. Nnwdaf_MLModelProvision_Subscribe may include direct AI positioning model, ML model filter information, and other information as defined in TS 23.288 [5].

The NWDAF including the MTLF may transmit the trained ML model information for AI positioning to the LMF/analytics logical function (AnLF) by invoking Nnwdaf_MLModelProvision_Notify as defined in TS 23.288 [5].

The NWDAF including the MTLF may have prepared the ML model for the AI positioning as requested before the subscription, but when the ML model is not ready, for example, no ML model is able to fulfil the accuracy requirement, then new ML model training and corresponding data collection procedure may be performed. The details for ML model training may be referred to clause 6.1.2.2.

In operation 340, the LMF 301 may collect data for an inference operation of the AI positioning model from the 5GC NF 303. The data may be for a learning and inference operation. Depending on the different positioning methods (e.g., UE assisted, or network assisted positioning) as defined in clause 6.11 of TS 23.273 [7], the LMF 301 may collect different measurement data from a UE (case 2b) or RAN (case 3b) for model inference to obtain a UE location.

In operation 350, the LMF 301 may generate location information of the UE by performing AI-based positioning based on the received information and collected data. The LMF may perform a model inference operation to derive UE location information based on the data collected from the UE (case 2b) or RAN (case 3b). The LMF may store the collected measurement data in the ADRF with the corresponding DataSetTag to perform an ML model inference operation and derive UE location information. ADRF ID and DataSetTag may indicate inference data stored in the ADRF, which may be used by the NWDAF including the MTLF to train or retrain the ML model.

Data privacy aspects with respect to the measurement data stored in the ADRF are beyond the scope of the disclosure and may be defined by service and system aspects working group 3 (SA WG3).

In operation 360, the LMF 301 may transmit the generated location information to the consumer NF 302. The LMF 301 may transmit the estimated UE location information to the UE or LCS client via the consumer NF 30 as defined in TS 23.273 [7].

Optionally, to monitor performance of ML models used in direct AI-based positioning, an ML model accuracy monitoring procedure as defined in clause 6.2D and 6.2E of TS 23.288 [5] may be reused.

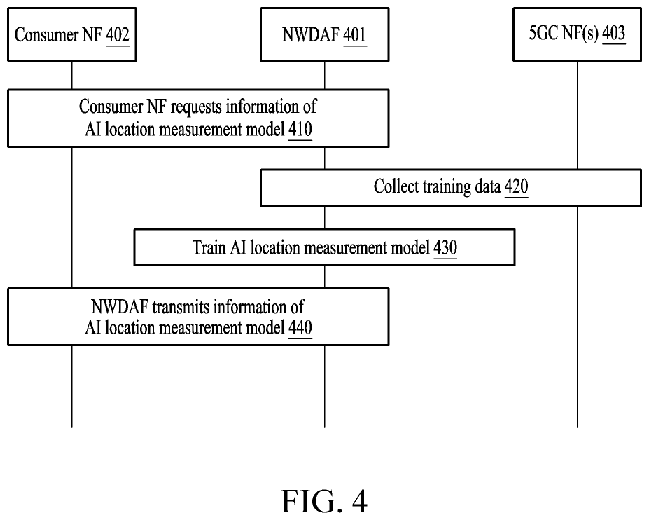

FIG. 4 is a flowchart illustrating a training method of an AI positioning model according to an embodiment. Referring to FIG. 4, in operation 410, the consumer NF 302 (e.g., LMF (e.g., the LMF 183 of FIG. 1) may request information of an AI positioning model to an NWDAF 401 (e.g., the NWDAF 180 of FIG. 1).

When an LMF determines to use an AI-based positioning method to obtain a UE location, the LMF may obtain a trained ML model from the NWDAF 401 including an MTLF. The LMF determining to obtain a trained ML model from the NWDAF 401 may be based on LMF implementation and/or based on ML model accuracy monitoring.

The LMF may request or subscribe to the NWDAF 401 including the MTLF for AI positioning.

In operation 420, the NWDAF 401 may collect training data for training the AI positioning model from a 5GC NF 403. For example, the 5GC NF 403 may include at least one of the NFs (e.g., the AMF 120, SMF 130, UPF 140, AF 150, PCF 160, NRF 170, NEF 175, MDAF 177, DCCF 185, ADRF 187, and UDM 189) of FIG. 1 and the NF 230 of FIG. 2.

Based on an ML model training request from a service consumer (in this case the LMF), the NWDAF 401 including the MTLF may initiate data (e.g., training data) collection required to train the ML model for direct AI positioning from a GMLC using an Ngmlc_Location_ProvideLocationMeasurement request for a UE or group of UEs (e.g., data collection per UE granularity), or for an area of interest (e.g., data collection per area granularity) which may be determined based on ML model filter information. The Ngmlc_Location_ProvideLocationMeasurement request may be triggered by data collection for ML model training rather than for an LCS request from an LCS client/consumer, and may include an indication that data is collected for training an AI model, a positioning method or measurement type (e.g., sounding reference signal (SRS) measurement and positioning reference signal (PRS) measurement) of positioning, a data source(s) (e.g., RAN, UE, and PRU) generating data, and a data time window (time interval [start . . . end]) for data collection.

User consent checking by the NWDAF 401 including the MTLF may be required before data collection.

The NWDAF 401 may select a UE for data collection based on UE functions (e.g., support for PRU) using various schemes.

The GMLC may invoke steps 3 to 5 in clause 6.8 of TS 23.273 [7] once per UE. The GMLC may invoke a Nudm_SDM_Get (LCS privacy, subscription permanent identifier (SUPI)) service operation towards a UDM to obtain a UE LCS privacy profile of the target UE. The GMLC may invoke a Nudm_UECM_Get service operation towards the UDM of the target UE with an SUPI of the corresponding UE. The UDM may return a current serving AMF ID to the GMLC.

Based on the serving AMF ID, the GMLC may transmit a Namf Location ProvideAIMLPosMeasurement Request to the AMF.

The AMF may perform LMF selection as defined in clause 5.1 of TS 23.273 [7] to select the LMF(s) serving the UE (or group of UEs) or select LMF(s) based on the area of interest.

The AMF may transmit an Nlmf_Location_MeasurementDataRequest to the selected LMF(s) with an AIML positioning indication to indicate that the measurement data request is for an AI positioning method.

When the requested measurement data is not available at the LMF or ADRF, the LMF may collect different measurement data from a UE (case 2b) or RAN (case 3b) for model training to obtain UE positioning data.

The LMF may store the measurement data in the ADRF.

The LMF may transmit an Nlmf_Location MeasurementData response to the AMF with the requested positioning data, or the LMF may transmit an ADRF ID and DataSetTag to the AMF when the LMF stores the measurement data.

The AMF may transmit to the GMLC an Namf Location ProvideAIMLPosMeasurement Response with the positioning data, or the ADRF ID and DataSetTag where the AI-based measurement data is stored.

The GMLC may aggregate one or more UE positioning data received or ADRF ID and DataSetTag reports in each message transmitted to the NWDAF 401 including MTLF.

Data privacy aspects with respect to the measurement data stored in the ADRF are beyond the scope of the disclosure and may be defined by SA3 WG.

In operation 430, the NWDAF 430 may train the AI positioning model based on training data collected from a selected UE. The NWDAF 430 including MTLF may train the ML model for direct AI positioning based on the data collected in operation 420.

In operation 440, the NWDAF 430 may transmit information of the AI positioning model for AI-based positioning to the consumer NF 402. The NWDAF 430 including the MTLF may transmit the trained ML model/information for direct AI positioning to the consumer NF 402 as requested in operation 410.

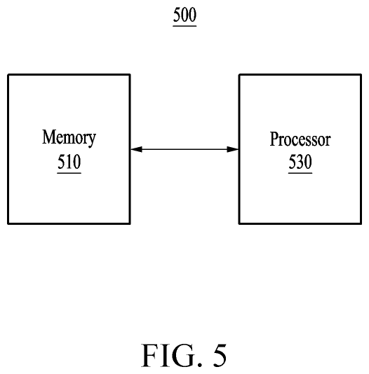

FIG. 5 is a schematic block diagram of a device for performing an NF according to an embodiment.

Referring to FIG. 5, according to an embodiment, a device 500 (e.g., a server device) for performing an NF may be substantially identical to the LMF (e.g., the LMF 183 of FIG. 1, the LMF 210 of FIG. 2, and the LMF 301 of FIG. 3) or the NWDAF (e.g., the NWDAF 180 of FIG. 1 and the NWDAF 401 of FIG. 4) described with reference to FIGS. 1 to 4. The device 500 may include memory 510 and a processor 530.

The memory 510 may store instructions (e.g., program) executable by the processor 530. For example, the instructions may include instructions for executing operations of the processor 530 and/or operations of each component of the processor 530.

The memory 510 may be implemented as a volatile memory device or a non-volatile memory device. The volatile memory device may be implemented as a dynamic random access memory (DRAM), a static random access memory (SRAM), a thyristor RAM (T-RAM), a zero capacitor RAM (Z-RAM), or a twin transistor RAM (TTRAM). The non-volatile memory device may be implemented as an electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), holographic memory, molecular electronic memory device, and/or insulator resistance change memory.

The processor 530 may execute computer-readable code (e.g., software) stored in the memory 510 and instructions triggered by the processor 530. The processor 530 may be a data processing device implemented as hardware having circuitry with a physical structure for executing desired operations. The desired operations may include, for example, code or instructions included in a program. The data processing device implemented as hardware may include, for example, a microprocessor, a central processing unit, a processor core, a multi-core processor, a multiprocessor, an application-specific integrated circuit (ASIC), and a field programmable gate array (FPGA).

Operations performed by the processor 530 may be substantially identical to the operations of the LMF (e.g., the LMF 183 of FIG. 1, the LMF 210 of FIG. 2, and the LMF 301 of FIG. 3) or the NWDAF (e.g., the NWDAF 180 of FIG. 1 and the NWDAF 401 of FIG. 4) described with reference to FIGS. 1 to 4. Therefore, a detailed description related thereto is omitted.

The embodiments described herein may be implemented using hardware components, software components, or a combination thereof. A processing device may be implemented using one or more general-purpose or special purpose computers, such as, for example, a processor, a controller and an arithmetic logic unit (ALU), a digital signal processor, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and/or data may be embodied in any type of machine, component, physical or virtual equipment, computer storage medium or device capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

While this disclosure includes embodiments, it will be apparent to one of ordinary skill in the art that various changes in form and details may be made in these embodiments without departing from the spirit and scope of the claims and their equivalents. The embodiments described herein are to be considered in a descriptive sense only, and not for purposes of limitation. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. An artificial intelligence (AI)-based positioning method, the method comprising:
receiving a request for positioning of a user equipment (UE) from a consumer network function (NF);
among legacy positioning and AI-based positioning, determining to perform the AI-based positioning for the positioning;
receiving information of an AI positioning model for the AI-based positioning from a fifth generation (5G) core (5GC) NF;
collecting data for a learning and inference operation of the AI positioning model from the 5GC NF;
generating location information of the UE by performing the AI-based positioning based on the received information and the collected data; and
transmitting the generated location information to the consumer NF.

2. The method of claim 1, wherein the collected data comprises:
a location of the UE collected according to a positioning scheme different from the AI-based positioning.

3. The method of claim 1, further comprising:
storing the generated location information in the 5GC NF to reuse the generated location information.

4. The method of claim 3, wherein the reusing comprises:
at least one of training and retraining of the AI positioning model.

5. The method of claim 1, wherein the method is performed by a location management function (LMF), and
the LMF is selected by an access and mobility management function (AMF) for the positioning of the UE based on at least one of an AI-based positioning support function and serving UE information.

6. The method of claim 5, wherein the AMF selects a different LMF based on at least one of the AI-based positioning support function and the serving UE information when the LMF is unable to normally support the AI-based positioning.

7. The method of claim 1, further comprising:
requesting discovery of a second NF supporting training of the AI positioning model to a first NF of the 5GC NF;
receiving information on the second NF from the 5GC NF; and
requesting the information of the AI positioning model to the second NF.

8. The method of claim 7, wherein the second NF pre-registers an NF profile comprising an indication of whether training of the AI positioning model is supported in the first NF.

9. The method of claim 7, wherein the second NF trains the AI positioning model based on training data collected from a selected UE.

10. The method of claim 9, wherein the training data is collected according to a request for positioning to the selected UE.

11. The method of claim 10, wherein the request for the positioning to the selected UE is triggered by data collection for the AI positioning model rather than a location service (LCS) request from an LCS client and an LCS consumer.

12. The method of claim 10, wherein the request for the positioning to the selected UE comprises:
an indication that data is collected for model training,
a positioning method or a measurement type of positioning,
a data source generating data, and
a data time window for data collection.

13. A server device for performing artificial intelligence (AI)-based positioning, the server device comprising:
a processor; and
memory electrically connected to the processor and storing instructions executable by the processor,
wherein the instructions, when executed by the processor, cause the server device to perform a plurality of operations,
wherein the plurality of operations comprise:
receiving a request for positioning of a user equipment (UE) from a consumer network function (NF);
among legacy positioning and AI-based positioning, determining to perform the AI-based positioning for the positioning;
receiving information of an AI positioning model for the AI-based positioning from a fifth generation (5G) core (5GC) NF;
collecting data for an inference operation of the AI positioning model from the 5GC NF;
generating location information of the UE by performing the AI-based positioning based on the received information and the collected data; and
transmitting the generated location information to the consumer NF.

14. The server device of claim 13, wherein the collected data comprises:
a location of the UE collected according to a positioning scheme different from the AI-based positioning.

15. The server device of claim 13, wherein the plurality of operations further comprises:
storing the generated location information in the 5GC NF to reuse the generated location information.

16. The server device of claim 15, wherein the reusing comprises:
at least one of training and retraining of the AI positioning model.

17. The server device of claim 13, wherein the plurality of operations is performed by a location management function (LMF), and
the LMF is selected by an access and mobility management function (AMF) for the positioning of the UE based on at least one of an AI-based positioning support function and serving UE information.

18. The server device of claim 17, wherein the AMF selects a different LMF based on at least one of the AI-based positioning support function and the serving UE information when the LMF is unable to normally support the AI-based positioning.

19. The server device of claim 13, wherein the plurality of operations further comprises:
requesting discovery of a second NF supporting training of the AI positioning model to a first NF of the 5GC NF;
receiving information on the second NF from the first NF of the 5GC NF; and
requesting the information of the AI positioning model to the second NF.

20. The server device of claim 19, wherein the second NF pre-registers an NF profile comprising an indication of whether training of the AI positioning model is supported in the first NF.
